(19) United States
(12) Patent Application Publication
(10) Pub. No.: US 2015/0380127 A1
(43) Pub. Date: Dec. 31, 2015

(54) INSULATING COMPOSITION AND COATED ELECTRIC WIRE USING THE SAME

(71) Applicant: YAZAKI CORPORATION, Tokyo (JP)

(72) Inventor: Masaki TANIGAWA, Shizuoka (JP)

(21) Appl. No.: 14/844,415

(22) Filed: Sep. 3, 2015

Related U.S. Application Data
(63) Continuation of application No. PCT/JP2013/085054, filed on Dec. 27, 2013.

(30) Foreign Application Priority Data
Mar. 13, 2013 (JP) 2013-050542

(51) Int. Cl. H01B 7/295; C08L 33/08; H01B 7/18; H01B 3/28; H01B 7/04; C08L 23/08; H01B 3/44

(52) U.S. Cl. CPC H01B 7/295; C08L 23/0869; C08L 33/08; H01B 3/447; H01B 3/441; H01B 3/28; H01B 7/041; H01B 7/18; C08L 2203/206

(57) ABSTRACT

An insulating composition of the present invention comprises: an ethylene copolymer having a Shore D hardness of 33 or higher and lower than 50; an ethylene-propylene-diene monomer copolymer or an acrylic rubber; and a metal hydroxide, wherein a mass ratio (A/B) of the ethylene copolymer (A) to the ethylene-propylene-diene monomer copolymer or the acrylic rubber (B) is 60/40 to 80/20. In addition, when the ethylene-propylene-diene monomer copolymer is contained, a mass ratio of the metal hydroxide is 70 to 80 parts by mass relative to 100 parts by mass of a total of the ethylene copolymer and the ethylene-propylene-diene monomer copolymer. When the acrylic rubber is contained, a mass ratio of the metal hydroxide is 60 to 100 parts by mass relative to 100 parts by mass of a total of the ethylene copolymer and the acrylic rubber.

### CROSS REFERENCE TO RELATED APPLICATION

This application is a Continuation of PCT Application No. PCT/JP2013/085054, filed on Dec. 27, 2013, and claims the priority of Japanese Patent Application No. 2013-050542, filed on Mar. 13, 2013, the content of all of which is incorporated herein by reference.

### BACKGROUND

1. Technical Field

The present invention relates to an insulating composition used for an electric wire to be wired in a vehicle such as an electric automobile and to a coated electric wire including the insulating composition as an insulating coating.

2. Related Art

Electric wires such as wire harnesses for electric automobiles are required to have flexibility, because they are wired with sharp bend in short routes in some cases. As an electric wire wired in such a place, an electric wire having an insulating coating of a soft silicone rubber has been used. However, although the coated electric wire using the silicone rubber has heat resistance, the coated electric wire has a problem of poor versatility because its poor resistance to acids and low strength impose some limitations on places where the coated electric wire can be used.

As described above, an electric wire used for an electric automobile is wired with a large bending stress in a wire harness protector, and hence is required to have flexibility. A conventional method for providing flexibility to an electric wire is reduction of the diameter of a metal conductor. However, the reduction of the diameter of a metal conductor necessitates the processing of the conductor, and hence causes the increase in production costs. In addition, when the diameter of a metal conductor is reduced, the metal conductor may be broken by vibrations. For this reason, instead of the reduction of the diameter of a metal conductor, a soft insulator has been employed as the insulator with which a metal conductor is coated (see, for example, Patent Literature 1).

In the electric wire described in Patent Literature 1, a cross-linked resin composition obtained by mixing an elastomer with an ethylene copolymer and further adding a metal hydroxide thereto is used as the insulating coating with which the metal conductor is coated.

Patent Literature 1: Japanese Unexamined Patent Application Publication No. 2008-84833

### SUMMARY

The insulating coating described in Patent Literature 1 has flexibility necessary for the wiring. However, the insulating coating has a low wear resistance, and hence may be easily damaged and broken by vibrations or the like. In addition, the insulating coating has such a low oil resistance that the insulating coating may be easily degraded upon contact with gasoline, engine oil, or the like, and may become useless in a short period.

The present invention has been made in view of the problems of the conventional technologies. An object of the present invention is to provide an insulating composition not only having flexibility, but also being excellent in wear resistance and oil resistance, and to provide a coated electric wire using the same.

An insulating composition according to a first aspect of the present invention comprises: an ethylene copolymer having a Shore D hardness of 33 or higher and lower than 50; an ethylene-propylene-diene monomer copolymer or an acrylic rubber; and a metal hydroxide. A mass ratio (AB) of the ethylene copolymer (A) to the ethylene-propylene-diene monomer copolymer or the acrylic rubber (B) is 60/40 to 80/20. Here, when the ethylene-propylene-diene monomer copolymer is contained, the mass ratio of the metal hydroxide is 70 to 80 parts by mass relative to 100 parts by mass of a total of the ethylene copolymer and the ethylene-propylene-diene monomer copolymer. Moreover, when the acrylic rubber is contained, a mass ratio of the metal hydroxide is 60 to 100 parts by mass relative to 100 parts by mass of a total of the ethylene copolymer and the acrylic rubber.

An insulating composition according to a second aspect of the present invention is the insulating composition according to the first aspect, wherein the ethylene copolymer includes at least one of an ethylene-ethyl acrylate copolymer and an ethylene-methyl acrylate copolymer.

A coated electric wire according to a third aspect of the present invention comprises: the insulating composition of the first or second aspect; and a metal conductor coated with the insulating composition.

### BRIEF DESCRIPTION OF DRAWINGS

FIG. 1 is a cross-sectional view showing a coated electric wire of an embodiment of the present invention.

FIG. 2 is a graph showing the relationship between the combination ratios of a metal hydroxide serving as a flame retardant and wear resistance.

FIG. 3 is a graph showing the relationship between the combination ratios of a metal hydroxide serving as a flame retardant and wear resistance.

FIG. 4 is a graph showing the relationship between oil resistance and Shore D hardness.

### DETAILED DESCRIPTION

Hereinafter, embodiments of the present invention will be described in detail by using the drawings. Note that some ratios of dimensions in the drawings are exaggerated for the sake of explanation, and may be different from actual ones.

The present inventor tested the flexibility, strength (tensile break strength), fluid resistance, and oil resistance of various materials with the intention of using the materials for coated electric wires. Table 1 shows the results of the tests, i.e., the results of the tests for the above-described properties of each of resin materials such as EVA, rubber materials such as HNBR, and elastomer materials selected as the materials.

Here, regarding the flexibility in Table 1, cases where the Shore D hardness is 32 or lower and the Shore A hardness is 82 or lower are evaluated as “∘ (Good),” whereas cases out of these ranges are evaluated as “× (Poor).” Regarding the tensile break strength, the results measured based on ASTM D638 are shown. Cases where the break strength is 10.3 MPa or higher are evaluated as “∘ (Good),” whereas cases where the break strength is lower than 10.3 MPa are evaluated as “× (Poor).” In addition, regarding the oil resistance (gasoline), the results measured based on a measurement method described later are shown. Cases where the rate of change after a durability test is 15% or less are evaluated as “∘ (Good),” whereas cases where the rate of change exceeds 15% are evaluated as “× (Poor).”

Note that the fluid resistance (battery fluid) in Table 1 was evaluated as follows. First, six tensile test pieces according to JIS K6251 were formed from each resin. Three of the tensile test pieces were immersed in a battery fluid at 50° C. for 20 hours. The three test pieces immersed in the battery fluid and the three test pieces not immersed in the battery fluid were subjected to a tensile test, and the average rate (%) of the elongation rate of the test pieces after the immersion to the elongation rate of the test pieces before the immersion (the elongation rate of the test pieces after the immersion/the elongation rate of the test pieces before the immersion ×100) was determined. Cases where the rate of change after the immersion is 50% or higher are evaluated as “∘ (Good),” whereas cases where the rate of change after the immersion is lower than 50% are evaluated as “× (Poor).”

In Table 1, “EVA” represents an ethylene-vinyl acetate copolymer (trade name: “EV170” (DUPONT-MITSUI POLYCHEMICALS CO., LTD). “EMA” represents an ethylene-methyl acrylate copolymer (trade name: “REXPEARL (registered trademark) EB230X” (Japan Polyethylene Corporation). “LLDPE” represents a linear low-density polyethylene (trade name: “KERNEL (registered trademark) KS240T” (Japan Polyethylene Corporation), and “LDPE” represents a low-density polyethylene (trade name: “LD400” (Japan Polyethylene Corporation).

“HNBR” represents a hydrogenated nitrile rubber, the “acrylic rubber” used was one available under the trade name of “VAMAC-DP” (manufactured by DuPont Elastomer Co., Ltd.), and the “fluororubber” used was one available under the trade name of “AFRAS150CS” (manufactured by Asahi Glass Co., Ltd.). “EPDM” represents an ethylene-propylene-diene monomer copolymer (trade name: “EPT3045H” (Mitsui Chemicals, Inc.). The “silicone rubber” used was one available under the trade name of “DY32-6066” (manufactured by Toray Industries, Inc.).

The “styrene-based elastomer” used was one available under the trade name of “SEPTON (registered trademark) 2063” (manufactured by KURARAY CO., LTD.), and the “polyurethane-based elastomer” used was one available under the trade name of “KURAMIRON (registered trademark)” (manufactured by KURARAY CO., LTD.). The “polyester-based elastomer” used was one available under the trade name of “PELPRENE (registered trademark) P-40H” (manufactured by Toyobo Co., Ltd.).

TABLE 1

| | | | | | Oil resistance |
|---|---|---|---|---|---|
| | | | | Fluid resistance | (gasoline) |
| | | Flexibility | | (battery fluid) | Rate of change |
| | Evaluated item | Shore D/ | Strength | Elongation ratio | after durability |
| | Evaluation | Shore A = | Break Strength is | after immersion is | test is 15% or |
| | criterion | 32/82 or lower | 10.3 MPa or higher | 50% or higher | lower |
| Resin material | EVA | ∘ | ∘ | ∘ | x |
| | EMA | x | ∘ | ∘ | ∘ |
| | LLDPE | x | ∘ | ∘ | ∘ |
| | LDPE | x | ∘ | ∘ | ∘ |
| Rubber material | HNBR | ∘ | ∘ | ∘ | ∘ |
| | (hydrogenated | | | | |
| | nitrile rubber) | | | | |
| | Acrylic rubber | ∘ | x | ∘ | ∘ |
| | Fluororubber | ∘ | ∘ | ∘ | ∘ |
| | EPDM | ∘ | ∘ | ∘ | x |
| | Silicone rubber | ∘ | x | x | ∘ |
| Elastomer | Styrene-based | ∘ | x | ∘ | x |
| material | elastomer | | | | |
| | Polyurethane- | ∘ | ∘ | x | ∘ |
| | based elastomer | | | | |
| | Polyester-based | x | ∘ | x | ∘ |
| | elastomer | | | | |

As shown in Table 1, the fluororubber is excellent in strength and chemical resistance, but is impractical for the use in a coated electric wire, because of its high costs. For this reason, the present inventor selected resin materials considering the costs, and blended rubber materials with the selected resin materials, and specified the combination ratios to achieve the desired flexibility. Consequently, the present inventor reached an insulating composition which has a high oil resistance and a high wear resistance, while retaining the flexibility. This has led to the completion of the present invention.

Specifically, an insulating composition of the present invention comprises: an ethylene copolymer having a Shore D hardness of 33 or higher and lower than 50; an ethylene-propylene-diene monomer copolymer; and a metal hydroxide. In addition, a mass ratio (A/B) of the ethylene copolymer (A) to the ethylene-propylene-diene monomer copolymer (B) is 60/40 to 80/20. In addition, in the case where the insulating composition contains the ethylene-propylene-diene monomer copolymer, a mass ratio of the metal hydroxide is 70 to 80 parts by mass relative to 100 parts by mass of a total of the ethylene copolymer and the ethylene-propylene-diene monomer copolymer.

Alternatively, the insulating composition of the present invention comprises: an ethylene copolymer having a Shore D hardness of 33 or higher and lower than 50; an acrylic rubber; and a metal hydroxide. In addition, a mass ratio (A/B) of the ethylene copolymer (A) to the acrylic rubber (B) is 60/40 to 80/20. Moreover, in the case where the insulating composition contains the acrylic rubber, a mass ratio of the metal hydroxide is 60 to 100 parts by mass relative to 100 parts by mass of a total of the ethylene copolymer and the acrylic rubber.

As the ethylene copolymer, one having a Shore D hardness of 33 or higher and lower than 50 is used. The hardness of the ethylene copolymer is evaluated based on whether or not the ethylene copolymer has a flexibility enough to withstand bending stress at the wiring and whether or not the ethylene copolymer has oil resistance against gasoline, engine oil, and the like, with a case where the insulating composition is used as an insulating coating of an electric wire taken into consideration. Here, when the Shore D hardness of the ethylene copolymer is lower than 33, the oil resistance is low. Meanwhile, when the Shore D hardness exceeds 50, a sufficient flexibility cannot be obtained, even if a flexible rubber material is blended. The ethylene copolymer of the present invention has a Shore D hardness in the range of 33 or higher and lower than 50, and this range is preferable for electric wiring.

Here, the hardness of the insulating composition varies depending on the kind of the ethylene copolymer, the kind of the rubber material blended with the ethylene copolymer, and the combination therebetween. In Table 2, the flexibility is evaluated at various combination ratios between ethylene copolymers and a rubber material on the premise that the strength (wear resistance) and oil resistance for an electric wire are satisfied. Note that, regarding the wear resistance and the oil resistance (gasoline), the results measured based on a measurement method described later are shown. Regarding the flexibility, cases where the Shore D hardness is 32 or lower and the Shore A hardness is 82 or lower are evaluated as “∘ (Good),” whereas cases out of these ranges are evaluated as “× (Poor).”

In Table 2, “HDPE” represents a high-density polyethylene (manufactured by Japan Polyethylene Corporation, trade name: “NOVATEC (registered trademark) HB332R”, Shore D hardness: 68). “EMA” represents an ethylene-methyl acrylate copolymer (manufactured by Japan Polyethylene Corporation, trade name: “REXPEARL (registered trademark) EB230X”, Shore D hardness: 37). “EEA” represents an ethylene-ethyl acrylate copolymer (manufactured by Japan Polyethylene Corporation, trade name: “REXPEARL (registered trademark) A4200”, Shore D hardness: 34). “LDPE” represents a low-density polyethylene (manufactured by Japan Polyethylene Corporation, trade name: “LD400”, Shore D hardness: 48). Finally, “EPDM” is an ethylene-propylene-diene monomer copolymer serving as a rubber material, and one available under the trade name of “EPT3045H” (manufactured by Mitsui Chemicals, Inc.) was used.

Table 2 shows that preferred combinations of a resin material and a rubber material with which the strength and the oil resistance are satisfied and the flexibility is satisfied are as follows. Specifically, the ethylene copolymer is an EMA or EEA having a Shore D hardness of 33 or higher and lower than 50, and the rubber material is EPDM. In addition, as shown in Table 2, the mass ratio (A/B) of the ethylene copolymer (A) to the EPDM (B) is 60/40 to 90/10. Note, however, that, to obtain a high flexibility even when a metal hydroxide is added, the mass ratio (A/B) of the ethylene copolymer (A) to the EPDM (B) is preferably 60/40 to 80/20, as shown in Examples described later.

By using an EPDM (ethylene-propylene-diene monomer copolymer) as the rubber material as described above, the rubber material and the ethylene copolymer can be well blended with each other. For this reason, it is possible to obtain an insulating composition for which a high wear resistance and a high oil resistance are reliably provided by the ethylene copolymer and flexibility is reliably provided by the rubber material.

TABLE 2

| | Combination ratios (parts by mass) and evaluation results | | | | | | | | | | | | | | | |
|---|---|---|---|---|---|---|---|---|---|---|---|---|---|---|---|---|
| HDPE | 90 | 80 | 70 | 60 | — | — | — | — | — | — | — | — | — | — | — | — |
| EMA | — | — | — | — | 90 | 80 | 70 | 60 | — | — | — | — | — | — | — | — |
| EEA | — | — | — | — | — | — | — | — | 90 | 80 | 70 | 60 | — | — | — | — |
| LDPE | — | — | — | — | — | — | — | — | — | — | — | — | 90 | 80 | 70 | 60 |
| EPDM | 10 | 20 | 30 | 40 | 10 | 20 | 30 | 40 | 10 | 20 | 30 | 40 | 10 | 20 | 30 | 40 |
| Flexibility | x | x | x | x | ∘ | ∘ | ∘ | ∘ | ∘ | ∘ | ∘ | ∘ | x | x | x | x |
| Strength | ∘ | ∘ | ∘ | ∘ | ∘ | ∘ | ∘ | ∘ | ∘ | ∘ | ∘ | ∘ | ∘ | ∘ | ∘ | ∘ |
| Oil | ∘ | ∘ | ∘ | ∘ | ∘ | ∘ | ∘ | ∘ | ∘ | ∘ | ∘ | ∘ | ∘ | ∘ | ∘ | ∘ |
| resistance | | | | | | | | | | | | | | | | |

Next, an acrylic rubber (ACM) was selected as the rubber material for the ethylene copolymer, namely, the EMA or EEA, and the combination ratio was examined on the premise that the strength and the oil resistance are satisfied as in the case of Table 2. Table 3 shows the results. In Table 3, the “ACM” used was one available under the trade name of “VAMAC-DP” (manufactured by DuPont Elastomer Co., Ltd.).

As shown in Table 3, in the cases where the strength and the oil resistance are satisfied, and also the flexibility is satisfied, the mass ratio (A/B) of the ethylene copolymer (A) to the ACM (B) is 60/40 to 90/10. Note, however, that to obtain a high flexibility even when a metal hydroxide is added, the mass ratio (A/B) of the ethylene copolymer (A) to the ACM (B) is preferably 60/40 to 80/20, as shown in Examples described later.

By using the ACM as the rubber material as described above, the rubber material can be well blended with the ethylene copolymer. For this reason, it is possible to obtain an insulating composition for which a high wear resistance and a high oil resistance are reliably provided by the ethylene copolymer, and flexibility is reliably provided by the rubber material.

TABLE 3

| | Combination ratios (parts by mass) and evaluation results | | | | | | | | | | | | | | | |
|---|---|---|---|---|---|---|---|---|---|---|---|---|---|---|---|---|
| HDPE | 90 | 80 | 70 | 60 | — | — | — | — | — | — | — | — | — | — | — | — |
| EMA | — | — | — | — | 90 | 80 | 70 | 60 | — | — | — | — | — | — | — | — |
| EEA | — | — | — | — | — | — | — | — | 90 | 80 | 70 | 60 | — | — | — | — |
| LDPE | — | — | — | — | — | — | — | — | — | — | — | — | 90 | 80 | 70 | 60 |
| ACM | 10 | 20 | 30 | 40 | 10 | 20 | 30 | 40 | 10 | 20 | 30 | 40 | 10 | 20 | 30 | 40 |
| Flexibility | x | x | x | x | ∘ | ∘ | ∘ | ∘ | ∘ | ∘ | ∘ | ∘ | x | x | x | x |
| Strength | ∘ | ∘ | ∘ | ∘ | ∘ | ∘ | ∘ | ∘ | ∘ | ∘ | ∘ | ∘ | ∘ | ∘ | ∘ | ∘ |
| Oil | ∘ | ∘ | ∘ | ∘ | ∘ | ∘ | ∘ | ∘ | ∘ | ∘ | ∘ | ∘ | ∘ | ∘ | ∘ | ∘ |
| resistance | | | | | | | | | | | | | | | | |

As described above, the insulating composition of the present invention comprises the ethylene copolymer having a Shore D hardness of 33 or higher and lower than 50 and the ethylene-propylene-diene monomer copolymer or the acrylic rubber. The insulating composition of the present invention further comprises a metal hydroxide as a flame retardant for providing flame retardancy.

As the metal hydroxide, one or more of metal compounds having hydroxy groups or water of crystallization such as magnesium hydroxide (Mg(OH)₂), aluminum hydroxide (Al(OH)₃), calcium hydroxide (Ca(OH)₂), basic magnesium carbonate (mMgCO₃.Mg(OH)₂.nH₂O), hydrated aluminum silicate (aluminum silicate hydrate, Al₂O₃.3SiO₂.nH₂O), and hydrated magnesium silicate (magnesium silicate pentahydrate, Mg₂Si₃O₈.5H₂O) can be used. Of these metal hydroxides, magnesium hydroxide is particularly preferable as the metal hydroxide.

Here, when the rubber materials is the EPDM, the combination ratio of the metal hydroxide is preferably 70 to 80 parts by mass relative to 100 parts by mass of the total of the ethylene copolymer and the EPDM. If the metal hydroxide is less than 70 parts by mass, there is a possibility that a sufficient flame retardancy cannot be provided. If the metal hydroxide exceeds 80 parts by mass, there is a possibility that flexibility necessary for an electric wire cannot be obtained.

On the other hand, when the rubber materials is the ACM, the combination ratio of the metal hydroxide is preferably 60 to 100 parts by mass relative to 100 parts by mass of the total of the ethylene copolymer and the ACM. As in the case where the rubber material is EPDM, if the combination ratio of the metal hydroxide is less than 60 parts by mass, there is a possibility that a sufficient flame retardancy cannot be provided, whereas if the combination ratio exceeds 100 parts by mass, there is a possibility that flexibility necessary for an electric wire cannot be obtained.

These metal hydroxides are preferably subjected to surface treatment in view of the compatibility with the resin material. However, even when not subjected to surface treatment, these metal hydroxides can be used, as long as the metal hydroxides do not deteriorate physical properties. The surface treatment on the metal hydroxide is preferably conducted by using a silane coupling agent, a titanate coupling agent, a fatty acid or fatty acid metal salt such as stearic acid or calcium stearate, or the like. One of the metal hydroxides may be used alone, or multiple kinds thereof may be used in combination.

In addition to the above-described essential components, various additives can be blended in the insulating composition of the present invention, as long as an effect of this embodiment is not impaired. The additives include flame retardant aid, antioxidant, metal deactivator, anti-aging agent, lubricant, filler, reinforcing agent, ultraviolet absorber, stabilizer, plasticizer, pigment, dye, coloring agent, antistat, foaming agent, and the like.

The insulating composition of the present invention as described above can have not only good flexibility in bending, but also a high oil resistance and a high wear resistance. For this reason, the use of this insulating composition as an insulating coating for an electric wire enables good wiring in a vehicle because of its high flexibility. Moreover, since the insulating composition of the present invention has a high strength, an electric wire having an improved durability can be obtained.

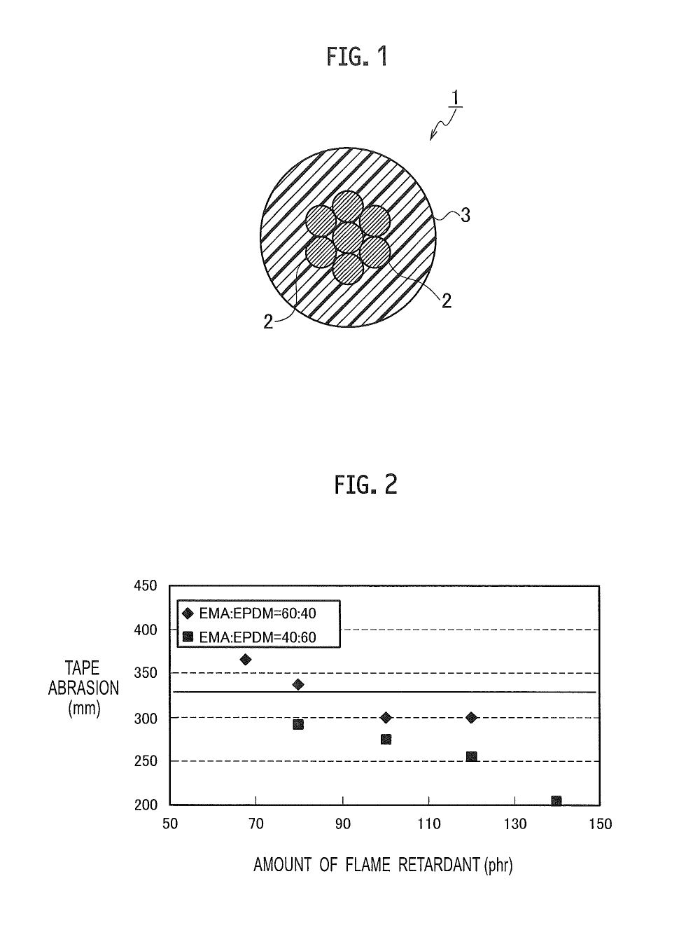

FIG. 1 shows an example of a coated electric wire 1 of this embodiment. The coated electric wire 1 is formed by coating a metal conductor 2 with an insulating coating layer 3.

The metal conductor 2 may include one constituent wire alone, or multiple constituent wires bundled together. In addition, the diameter, the material, or the like of the metal conductor 2 is not particularly limited, and can be determined as appropriate depending on the application. As a material of the metal conductor 2, a known electrically conductive metal material such as copper, a copper alloy, aluminum, or an aluminum alloy can be used.

Next, a method for manufacturing a coated electric wire of this embodiment is described. The insulating coating layer 3 of the coated electric wire 1 is prepared by kneading the above-described materials, and a known technique can be used for the method for the kneading. For example, the insulating composition to constitute the insulating coating layer 3 can be obtained by preblending the materials by using a high-speed mixer such as a Henschel mixer in advance, and then kneading the preblend by using a known kneading apparatus such as a Banbury mixer, a kneader, or a roll mill.

Moreover, a known technique can be used also as a method for coating the metal conductor 2 with the insulating coating layer 3 in the coated electric wire of this embodiment. For example, the insulating coating layer 3 can be formed by an ordinary extrusion molding method. In addition, as an extruder used in the extrusion molding method, for example, a single-screw extruder or twin-screw extruder can be used, which may be provided with a screw, a breaker plate, a cross head, a distributor, a nipple, and a die.

In addition, when the insulating composition of the insulating coating layer 3 is prepared, the ethylene copolymer and the rubber material are introduced into a twin-screw extruder set at a temperature where the ethylene copolymer and the rubber material are sufficiently melted. Here, the metal hydroxide, and further, if necessary, other components such as a flame retardant aid and an antioxidant are also introduced. Then, the ethylene copolymer, the rubber material and the like are melted and kneaded with screws, and a certain amount of the kneaded materials is supplied to a cross head through a breaker plate. The melt of the ethylene copolymer, the rubber material and the like flows through a distributor onto the circumference of a nipple, and is extruded through a die in a state of being coated on the outer periphery of the conductor. In this manner, the insulating coating layer 3 coating the outer periphery of the metal conductor 2 can be obtained.

In the coated electric wire 1, the insulating coating layer 3 is formed by the insulating composition having a good flexibility as well as a high oil resistance and a high wear resistance. For this reason, the obtained electric wire has a good flexibility in bending, as well as oil resistance against gasoline and the like and wear resistance against wire breakage and the like. Consequently, the coated electric wire 1 can be used suitably for wiring in a vehicle such as an electric automobile.

### EXAMPLES

Hereinafter, the present invention will be described in further detail based on Examples and Comparative Examples; however, the present invention is not limited to these Examples.

In the following Examples, coated electric wires were fabricated by using pure copper as a metal conductor, and coating the metal conductor with insulating compositions by extrusion molding. Then, the oil resistance, the wear resistance, and the flame retardancy were evaluated by using these coated electric wires as test samples. Note that each coated electric wire was fabricated with the outer diameter being 3.70 mm and with the thickness of the insulating coating made of the insulating composition being 0.7 mm.

The oil resistance was evaluated according to ISO6722. Specifically, the outer diameter of a test sample is measured before immersion in gasoline. Next, the test sample is immersed in gasoline and left in the gasoline for 30 minutes. After the immersion, the test sample is taken out of the gasoline, and the gasoline attached to the surface is wiped away. Then, the outer diameter is measured at the same portion as that before the immersion. Cases where the rate of change of the outer diameter after the immersion in gasoline to the outer diameter before the immersion (the outer diameter after the immersion/the outer diameter before the immersion ×100) was 15% or lower were evaluated as “∘ (Good),” whereas cases where the rate of change exceeded 15% were evaluated as “× (Poor).”

The wear resistance was evaluated based on tape abrasion. Specifically, a test sample having a length of 900 mm was fixed, an abrasive tape No. 150 G specified in JIS R6251 was brought into contact with the test sample, and a weight of 500 g was applied to the abrasive tape. In this state, the abrasive tape was moved at a rate of 1500 mm/min, and the length of the abrasive tape moved before the test sample was worn to an extent that the metal conductor and the abrasive tape came into contact with each other. Cases where the length before the contact was 330 mm or more were evaluated as “∘ (Good),” whereas cases where the length was less than 330 mm were evaluated as “× (Poor).”

For evaluation of the flame retardancy, each test sample was placed in a draft chamber at an angle of 45 degrees, and subjected to the flame-retardant test specified in ISO6722. Specifically, for each test sample having a metal conductor cross-sectional area of 2.5 mm² or less, an inner flame portion of a Bunsen burner was kept in contact with a lower edge of the test sample for 15 seconds, and then the test sample was taken away from the Bunsen burner. Meanwhile, for each test sample having a metal conductor cross-sectional area exceeding 2.5 mm², an inner flame portion of a Bunsen burner was kept in contact with a lower edge of the test sample for 30 seconds, and then the test sample was taken away from the Bunsen burner. Here, cases where the flame on the insulating coating completely went out within 70 seconds after the Bunsen burner was taken away from the test sample and the length of the insulating coating of the test sample left unburned was 50 mm or more were evaluated as “∘ (Good).” Cases where the test sample continued to burn more than 70 seconds after the Bunsen burner was taken away from the test sample, or the length of the insulating coating of the test sample left unburned was less than 50 mm were evaluated as “× (Poor).”

### [Amount of Metal Hydroxide Added]

By using an EMA as the ethylene copolymer, an EPDM as the rubber material and magnesium hydroxide as the metal hydroxide with the mass ratio of the EMA to the EPDM being 60:40 (parts by mass), multiple test samples were prepared among which the amount of magnesium hydroxide added was varied. Then, these test samples were evaluated in terms of the relationship between the combination ratio of the metal hydroxide and the flame retardancy. Specifically, as shown in Table 4, the combination ratio of magnesium hydroxide was varied within a range where the flexibility (the Shore D hardness was 32 or lower and the Shore A hardness was 82 or lower) was satisfied, and the flame retardancy was evaluated. The EMA and EPDM used were ones available under the above-described trade names, and the magnesium hydroxide used was one available under the trade name of “KISUMA (registered trademark) 5A” (Kyowa Chemical Industry Co., Ltd.).

TABLE 4

| | Combination ratios | | | | |
|---|---|---|---|---|---|
| | (parts by mass) and evaluation results | | | | |
| EMA | 60 | 60 | 60 | 60 | 60 |
| EPDM | 40 | 40 | 40 | 40 | 40 |
| Magnesium | 40 | 60 | 70 | 80 | 140 |
| hydroxide | | | | | |
| Flexibility | ∘ | ∘ | ∘ | ∘ | ∘ |
| Flame | x | x | ∘ | ∘ | ∘ |
| retardancy | | | | | |

As shown in Table 4, it can be seen that the flame retardancy degrades, when the EPDM is used as the rubber material and the magnesium hydroxide is less than 70 parts by mass.

Further, with the mass ratio of the EMA to the EPDM being 60:40, multiple test samples were prepared among which the amount of magnesium hydroxide added was varied. Then, these test samples were evaluated in terms of the relationship between the combination ratio of the metal hydroxide and the wear resistance. FIG. 2 shows the evaluation results. As shown in FIG. 2, when the combination ratio of magnesium hydroxide was 80 parts by mass or lower relative to 100 parts by mass of the resin using the EPDM as the rubber material, the length of the abrasive tape was 330 mm or more, indicating an excellent wear resistance. In contrast, it can be seen that when the combination ratio of magnesium hydroxide exceeded 80 parts by mass, the wear resistance was degraded.

Note that FIG. 2 also shows the evaluation results of the wear resistance in the case where the combination ratio of the metal hydroxide was varied with the mass ratio of the EMA to the EPDM being 40:60. From FIG. 2, it can be seen that when the combination ratio of the EMA serving as the ethylene copolymer is less than 60 parts by mass, a sufficient wear resistance cannot be obtained, and the durability is poor for an electric wire for a vehicle.

Next, by using an EMA as the ethylene copolymer, an ACM as the rubber material and magnesium hydroxide as the metal hydroxide with the mass ratio of the EMA to the ACM being 60:40 (parts by mass), multiple test samples were prepared among which the amount of magnesium hydroxide added was varied. In addition, by using an EMA as the ethylene copolymer, an ACM as the rubber material and magnesium hydroxide as the metal hydroxide with the mass ratio of the EMA to the ACM being 70:30 (parts by mass), multiple test samples were also prepared among which the amount of magnesium hydroxide added was varied. Then, these test samples were evaluated in terms of the relationship between the combination ratio of the metal hydroxide and the flame retardancy. Note that the EMA, ACM and magnesium hydroxide used were ones available under the above-described trade names.

TABLE 5

Combination ratios (parts by mass)
and evaluation results

| | | | | | | |
|---|---|---|---|---|---|---|
| EMA | 70 | 70 | 70 | 60 | 60 | 60 |
| ACM | 30 | 30 | 30 | 40 | 40 | 40 |
| Magnesium | 60 | 80 | 140 | 60 | 80 | 140 |
| hydroxide | | | | | | |
| Flexibility | ∘ | ∘ | x | ∘ | ∘ | ∘ |
| Flame | ∘ | ∘ | ∘ | ∘ | ∘ | ∘ |
| retardancy | | | | | | |

As shown in Table 5, it can be seen that when the ACM is used as the rubber material and the magnesium hydroxide is 60 parts by mass or more, a sufficient flame retardancy can be obtained. However, the flexibility decreases, when the magnesium hydroxide is 140 parts by mass or more.

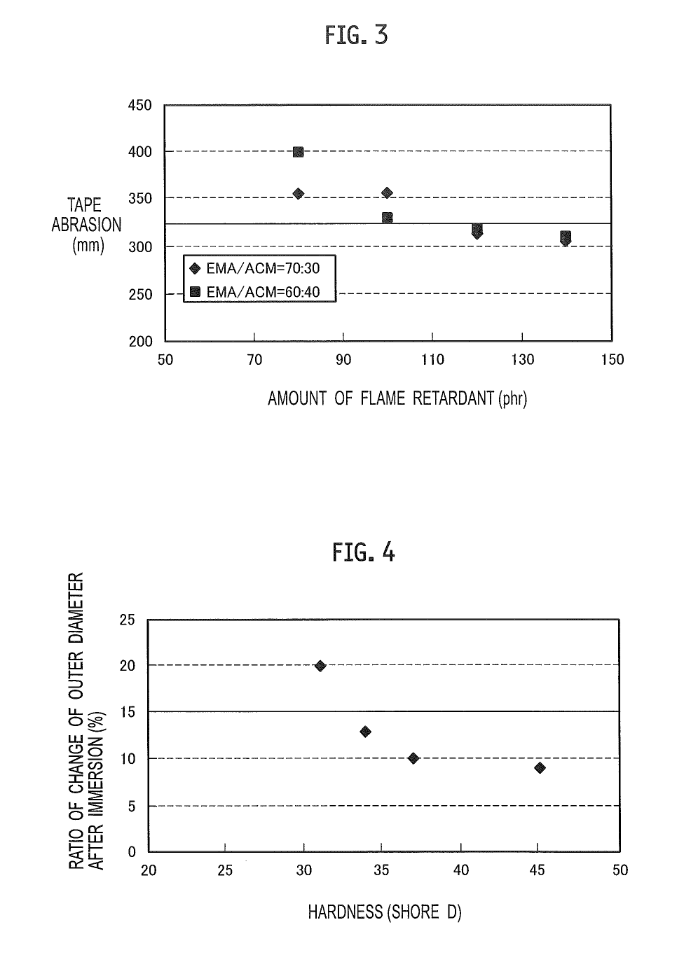

Moreover, multiple test samples were prepared among which the amount of magnesium hydroxide added was varied with the mass ratio of the EMA to the ACM being 60:40, and multiple test samples were prepared among which the amount of magnesium hydroxide added was varied with the mass ratio of the EMA to the ACM being 70:30. These test samples were evaluated in terms of the relationship between the combination ratio of the metal hydroxide and the wear resistance. FIG. 3 shows the evaluation results. As shown in FIG. 3, when the combination ratio of magnesium hydroxide was 100 parts by mass or lower relative to 100 parts by mass of the resin using the ACM as the rubber material, the length of the abrasive tape was 330 mm or more, indicating an excellent wear resistance. It can be seen that, in contrast, when the combination ratio of magnesium hydroxide exceeds 100 parts by mass, the wear resistance decreases.

### [Hardness of Ethylene Copolymer]

As the ethylene copolymers, an EEA having a Shore D hardness of 31, an EEA having a hardness of 34, an EMA having a hardness of 37, and an EMA having a hardness of 45 were prepared. Then, test samples were prepared by using the ethylene copolymers, an EPDM as the rubber material, and magnesium hydroxide as the metal hydroxide with the mass ratio of the EMA to the EPDM being 60:40 (parts by mass) and further with the magnesium hydroxide being 80 parts by mass. Table 6 shows the materials and the combination ratio of each test sample.

Note that the EEA having a Shore D hardness of 31 used was one available under the trade name of “ELVALOY (registered trademark) AC2116” (DUPONT-MITSUI POLYCHEMICALS CO., LTD), and the EEA having a Shore D hardness of 34 used was one available under the trade name of “REXPEARL (registered trademark) A4200” (Japan Polyethylene Corporation). The EMA having a Shore D hardness of 37 used was one available under the trade name of “REXPEARL (registered trademark) EB230X” (Japan Polyethylene Corporation), and the EMA having a Shore D hardness of 45 used was one available under the trade name of “ELVALOY (registered trademark) AC1913” (DUPONT-MITSUI POLYCHEMICALS CO., LTD). In addition, the EPDM used was one available under the trade name of “EPT3045H” (Mitsui Chemicals, Inc.). In addition, the magnesium hydroxide used was one available under the trade name of “KISUMA (registered trademark) 5A” (Kyowa Chemical Industry Co., Ltd.).

TABLE 6

Combination ratios (parts by
mass) and evaluation results

| | | | | |
|---|---|---|---|---|
| EEA (Shore D: 31) | 60 | — | — | — |
| EEA (Shore D: 34) | — | 60 | — | — |
| EMA (Shore D: 37) | — | — | 60 | — |
| EMA (Shore D: 45) | — | — | — | 60 |
| EPDM | 40 | 40 | 40 | 40 |
| Magnesium hydroxide | 80 | 80 | 80 | 80 |

Then, the test samples shown in Table 6 were evaluated in terms of the oil resistance against gasoline. As shown in FIG. 4, it can be seen that when an EMA or EEA having a Shore D hardness of 33 or higher is used, the oil resistance is excellent.

### [Combination Ratio of Rubber Material]

Test samples were prepared by blending an EEA having a Shore D hardness of 34, an ACM or EPDM as the rubber material and magnesium hydroxide at the ratios shown in Table 7. Note that each of the EEA, ACM, EPDM and magnesium hydroxide used was one available under the above-described trade name.

TABLE 7

| | Combination ratios (parts by mass) | | | | | | |
|---|---|---|---|---|---|---|---|
| | and evaluation results | | | | | | |
| EEA | 70 | 80 | 90 | 70 | 80 | 90 | 80 |
| (Shore D: 34) | | | | | | | |
| ACM | — | — | — | 30 | 20 | 10 | 20 |
| EPDM | 30 | 20 | 10 | — | — | — | — |
| Magnesium | 80 | 80 | 80 | 60 | 60 | 60 | 100 |
| hydroxide | | | | | | | |
| Flexibility | ∘ | ∘ | x | ∘ | ∘ | x | ∘ |
| Oil resistance | ∘ | ∘ | ∘ | ∘ | ∘ | ∘ | ∘ |

Then, each test sample was evaluated in terms of the flexibility (the Shore D hardness was 32 or lower and the Shore A hardness was 82 or lower) and the oil resistance. Table 7 collectively shows the evaluation results. As shown in Table 7, it can be seen that the flexibility decreases, when the EEA having a Shore D hardness of 34 is used with each of the rubber materials, and when the ethylene copolymer exceeds 80 parts by mass and the rubber material is less than 20 parts by mass.

The insulating composition of the present invention has not only good flexibility in bending, but also a high oil resistance and a high wear resistance. For this reason, the use of this insulating composition as an insulating coating for an electric wire makes it possible to obtain an electric wire having a good flexibility as well as a high oil resistance and a high wear resistance. In addition, such an electric wire has a high durability, and can be suitably wired in a vehicle.

The present invention is described based on Examples above; however, the present invention is not limited thereto, and various modifications can be made within the gist of the present invention. For example, one of EMA and EEA serving as the ethylene copolymer may be used alone, or the both may be used in combination. In addition, it is not necessary to blend one of EPDM and ACM serving as the rubber material alone, but a mixture of EPDM and ACM can be blended with the ethylene copolymer.

What is claimed is:

1. An insulating composition comprising:
an ethylene copolymer having a Shore D hardness of 33 or higher and lower than 50;
an ethylene-propylene-diene monomer copolymer or an acrylic rubber; and
a metal hydroxide, wherein
a mass ratio (A/B) of the ethylene copolymer (A) to the ethylene-propylene-diene monomer copolymer or the acrylic rubber (B) is 60/40 to 80/20,
when the ethylene-propylene-diene monomer copolymer is contained, a mass ratio of the metal hydroxide is 70 to 80 parts by mass relative to 100 parts by mass of a total of the ethylene copolymer and the ethylene-propylene-diene monomer copolymer, and
when the acrylic rubber is contained, a mass ratio of the metal hydroxide is 60 to 100 parts by mass relative to 100 parts by mass of a total of the ethylene copolymer and the acrylic rubber,
wherein the ethylene copolymer includes at least one of an ethylene-ethyl acrylate copolymer and an ethylene-methyl acrylate copolymer.

2. A coated electric wire comprising:
the insulating composition according to claim 1; and
a metal conductor coated with the insulating composition.
